(19) United States
(12) Patent Application Publication
(10) Pub. No.: US 2022/0183808 A1
(43) Pub. Date: Jun. 16, 2022

(54) Removing Device for Dentistry

(71) Applicant: Jui Yuan Shih, Lukang Township (TW)

(72) Inventor: Jui Yuan Shih, Lukang Township (TW)

(21) Appl. No.: 17/542,622

(22) Filed: Dec. 6, 2021

(30) Foreign Application Priority Data
Dec. 11, 2020 (TW) 109143969

(51) Int. Cl. A61C 17/12; A61C 17/08

(52) U.S. Cl. CPC A61C 17/13; A61C 17/08

(57) ABSTRACT

A removing device for dentistry has a connecting pipe, a controller, and a sucking tube. The controller is connected to the connecting pipe and has two connecting portions and an operating portion between the two connecting portions. The two connecting portions connect in fluid communication with each other via the operating portion. One of the connecting portions is connected to the connecting pipe. The operating portion has at least one relief hole disposed on an external surface thereof and in fluid communication with the connecting portions and a flow regulator. The sucking tube is connected to the other connecting portion opposite to the connecting pipe to connect in fluid communication with the connecting pipe via the controller. By pressing the operating portion to shield the relief hole or adjust the flow regulator to control the suction force, the removing device for dentistry can be used conveniently and removed quickly.

### BACKGROUND OF THE INVENTION

### 1. Field of the Invention

The present invention relates to a removing device for dentistry, and more particularly to a removing device for dentistry that can be used and manufactured conveniently and can be removed quickly.

### 2. Description of Related Art

With the advancement and development of science and technology, the current technology and equipment related to dental health and treatment are also flourishing. In a process of dental health care and treatment, it is often necessary to use a conventional water suction/high power suction to draw out the patient's saliva and rinsing fluid to avoid leaving the saliva or rinsing fluid in the patient's mouth that may affect subsequent related operations. However, the conventional water suction/high power suction is mainly a hard structure made of materials such as plastic or metal. During the operation, it may cause a collision that hurts the patient, and the materials of the hard structure cannot be adjusted as needed, which relatively restricts the practicability of the conventional water suction/high power suction.

Furthermore, dental implants have gradually become one of the indispensable life necessities of people. During the process of implanting dental implants, according to the condition of atrophy of the patient's gums, different amounts of bone graft will be filled into the patient's alveolar bone. By means of structural restoration and reinforcement of the patient's gums, it can be ensured that when the dental implant is implanted in the patient's gums, it can be firmly set on the patient's alveolar bone. Additionally, in the process of dental implantation, it is necessary to drill holes in the alveolar bone, so that the dental implant is set in the alveolar bone and fixed with the filled bone graft.

However, when a dentist drills a hole in a posterior area of an upper jaw of the patient, it is easy to drill the sinus membrane near the posterior area of the upper jaw. At this time, if the dentist does not notice that the sinus membrane is broken and fills the bone graft into the hole, the bone graft may enter the sinus cavity through the broken sinus membrane. Since there is no related technology to remove the bone graft that has fallen into the sinus cavity, it can only be expected that the bone graft may be discharged into the nasal cavity through the sinus opening of the maxillary sinus that communicates with the sinus cavity. When the bone graft in the sinus cavity cannot be discharged smoothly through the sinus opening of the maxillary sinus, it will cause the bone graft to block the sinus opening of the maxillary sinus, and infection and suppuration inside the sinus cavity will cause the sinus of the maxillary sinus infection. In severe cases, the bacteria will spread into the brain, causing damage to the brain that can be life-threatening. At this time, the patient can only be transferred to an otolaryngologist through functional endoscopic sinus surgery (FESS), which is quite risky for patients and is likely to cause medical disputes. Therefore, improvement is needed to the current technology and equipment related to the use of bone graft for dental implants.

### SUMMARY OF THE INVENTION

Therefore, in view of the defects and deficiencies of the structure and use of the conventional water suction/high power suction and techniques and equipment of applying bone graft for dental implants, the present invention has finally been developed to improve on the existing defects through continuous research and experimentation.

The main objective of the present invention is to provide a removing device for dentistry that can be quickly used with a hard water suction/high power suction through a simplified structural configuration, and can be used in a process of filling bone graft. If the bone graft enters the sinus cavity through the broken sinus membrane, the bone graft that enters the sinus cavity can be removed by a sucking way to avoid the bone graft remaining in the sinus cavity causing subsequent infection and suppuration due to obstruction. It is relatively convenient to use and can prevent subsequent surgeries or life-threatening conditions, so as to provide a removing device for dentistry that can be used and manufactured conveniently and can be removed quickly.

In order to achieve the above objective, the present invention mainly provides a removing device for dentistry, the removing device comprising:
a connecting pipe;
a controller, the controller connected to the connecting pipe and having
   two connecting portions, and one of the two connecting portions connected to the connecting pipe; and
   an operating portion disposed between the two connecting portions to connect the two connecting portions in fluid communication with each other and
a sucking tube, the sucking tube connected to the other one of the two connecting portions opposite to the connecting pipe to connect in fluid communication with the connecting pipe via the controller.

According to the above-mentioned technical features, when the removing device for dentistry of the present invention is in use, the dentist only needs to move the sucking tube to the alveolar bone of the patient, and then through the operating portion or press the operating portion to fully open, fully shield, half shield or partially shield the at least one relief hole or adjust the flow regulator to accurately control the operation of the suction force. It is convenient to perform the removal operation of the bone graft. This not only removes the bone graft entering into the sinus cavity quickly, and also avoids the infection and suppuration of the sinus of the maxillary sinus due to the bone graft blocking the sinus opening of the maxillary sinus. This also avoids the subsequent need to transfer the patient to an otolaryngologist for surgery, avoiding life-threatening conditions and medical disputes derived therefrom. In addition, the removing device for dentistry of the present invention has a simplified structure that can be manufactured and produced conveniently, and allows the dentist to operate easily and quickly get started, and effectively solves the problem of the surgeon's implantation for the problems encountered during the dental process, to provide a removing device for dentistry that can be used and manufactured conveniently and can be removed quickly.

### BRIEF DESCRIPTION OF THE DRAWINGS

FIG. 1 is a perspective view of a first embodiment of a removing device for dentistry in accordance with the present invention;

FIG. 2 is a schematic diagram showing that a hole formed through a sinus membrane during a dental implantation process and bone graft entering a sinus cavity;

FIG. 3 is an operational side view in partial section of the first embodiment of the removing device for dentistry of the present invention;

FIG. 4 is another operational side view in partial section of the first embodiment of the removing device for dentistry of the present invention;

FIG. 5 is an exploded and enlarged perspective view of a second embodiment of a removing device for dentistry in accordance with the present invention;

FIG. 6 is an enlarged top side view of a third embodiment of a removing device for dentistry in accordance with the present invention;

FIG. 7 is an enlarged cross sectional side view of the third embodiment of the removing device for dentistry of the present invention;

FIG. 8 is an operational side view in partial section of the third embodiment of the removing device for dentistry of the present invention;

FIG. 9 is another operational side view in partial section of the third embodiment of the removing device for dentistry of the present invention;

FIG. 10 is a perspective view of a fourth embodiment of a removing device for dentistry in accordance with the present invention;

FIG. 11 is a perspective view of a fifth embodiment of a removing device for dentistry in accordance with the present invention;

FIG. 12 is an enlarged top side view of the fifth embodiment of the removing device for dentistry of the present invention;

FIG. 13 is a perspective view of a sixth embodiment of a removing device for dentistry in accordance with the present invention;

FIG. 14 is an enlarged top side view of the sixth embodiment of the removing device for dentistry of the present invention;

FIG. 15 is an operational side view in partial section of the sixth embodiment of the removing device for dentistry of the present invention;

FIG. 16 is a perspective view of a seventh embodiment of a removing device for dentistry in accordance with the present invention;

FIG. 17 is an operational side view in partial section of the seventh embodiment of the removing device for dentistry of the present invention;

FIG. 18 is a perspective view of an eighth embodiment of a removing device for dentistry in accordance with the present invention;

FIG. 19 is an enlarged cross sectional side view of a sucking tube of the removing device for dentistry of the present invention; and

FIG. 20 is an operational side view in partial section of the eighth embodiment of the removing device for dentistry of the present invention.

### DETAILED DESCRIPTION OF PREFERRED EMBODIMENT

To be able to learn more about the technical features and practical efficacy of the present invention, in accordance with the instructions, to implement further the figures shown in the preferred embodiment, details are as follows:

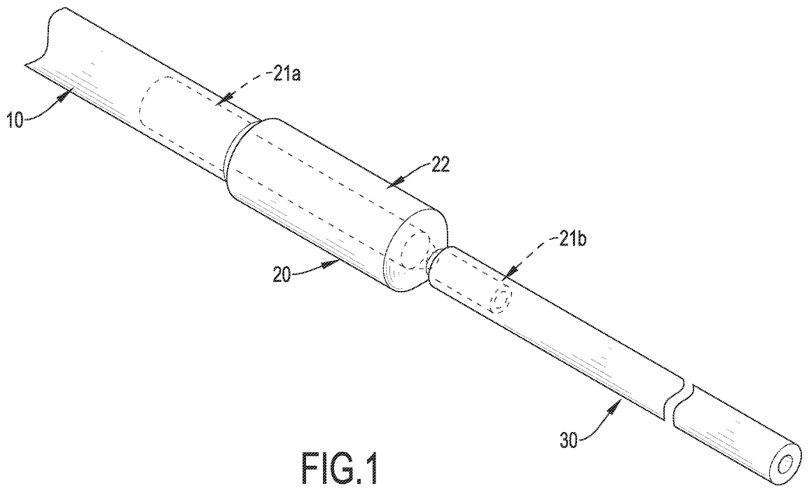

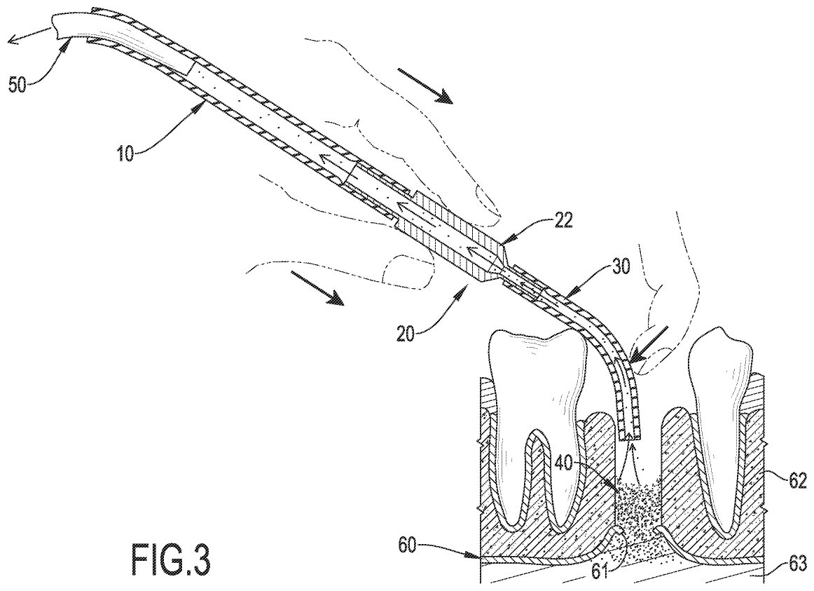

The present invention is a removing device for dentistry; with reference to FIG. 1, a first embodiment of a removing device for dentistry in accordance with the present invention comprises a connecting pipe 10, a controller 20, and a sucking tube 30. Each of the connecting pipe 10 and the sucking tube 30 is made of a soft material, and an end of the connecting pipe 10 is connected to a hard water suction/high power suction 50 as shown in FIG. 3. The controller 20 is a hollow jacket and has two connecting portions 21a, 21b and an operating portion 22 disposed between the two connecting portions 21a, 21b. Furthermore, the two connecting portions 21a, 21b are respectively a first connecting portion 21a and a second connecting portion 21b, and the two connecting portions 21a, 21b are in fluid communication with each other via the operating portion 22. The first connecting portion 21a is connected to the connecting pipe 10, and the second connecting portion 21b is distal from the connecting pipe 10 and connected to the sucking tube 30.

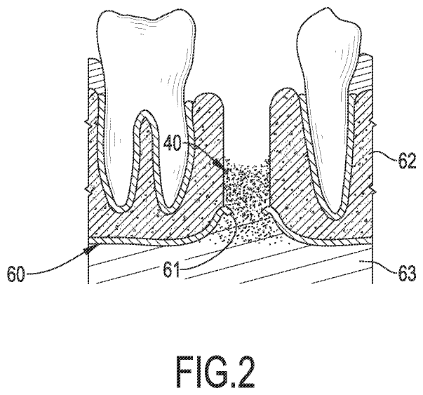

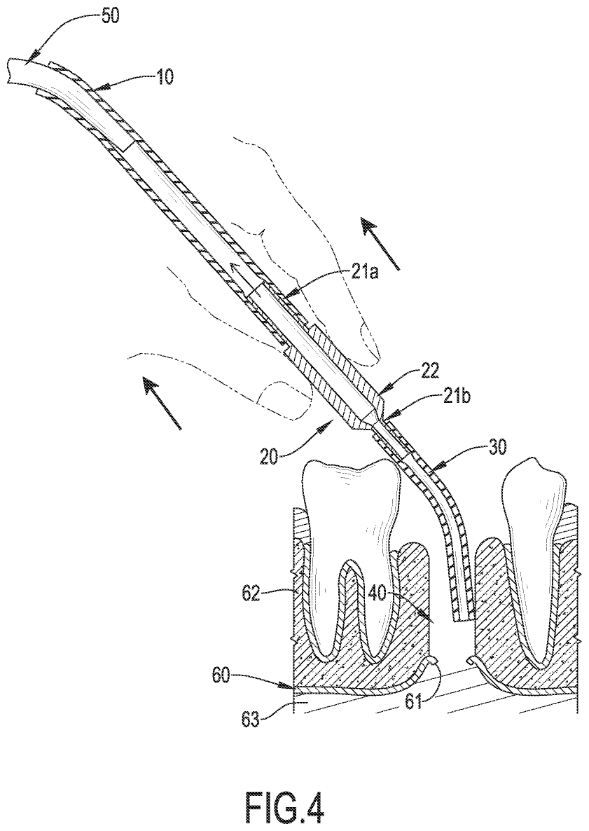

With reference to FIGS. 2, 3, and 4, when the first embodiment of the removing device for dentistry of the present invention is in use, the connecting pipe 10 that is made of a soft material is connected to the water suction/high power suction 50, and a dentist can hold the sucking tube 30 far away from the connecting pipe 10 to draw out liquid such as the patient's saliva and washing fluid, so as to avoid leaving it in the patient's mouth and affecting subsequent related operations. During the operation, the suction tube 30 made of a soft material not only avoids the pain caused by collision, but also can be adjusted according to the needs of the dentist, which greatly improves the practicability of the water suction/high power suction 50. Furthermore, when the patient's sinus membrane 60 is drilled to form a hole 61 during the dental implantation process, as shown in FIG. 2, and when the bone graft 40 is filled in a corresponding alveolar bone 62 passes through the hole 61 and enters the sinus cavity 63, the dentist, upon finding this situation, can connect the connecting pipe 10 with the water suction/high power suction 50 as shown in FIG. 3, and holds the controller 20 with one hand to move the sucking tube 30 adjacent to the corresponding alveolar bone 62 of the patient, or the other hand assists in moving the sucking tube 30 to the corresponding alveolar bone 62. So the gas suction force in the water suction/high power suction 50 can be transmitted to the sucking tube 30, and the bone graft 40 that enters the sinus cavity 63 can be sucked out through the sucking tube 30 to prevent the bone graft 40 from blocking the sinus opening of the maxillary sinus and causing infection and suppuration in the sinus cavity 63. Additionally, during the operation of removing the bone graft 40, the dentist can control the sucking tube 30 to approach or move away from the alveolar bone 62 through the fingers as shown in FIG. 4, so that the sucking tube 30 generates an intermittent suction force to the bone graft 40. Firstly, it can cooperate with the dentist to adjust the suction force for the actual situation. Secondly, it can avoid the continuous suction force from affecting the patient. It is very convenient to use and operate, and it can quickly remove the bone graft 40 that enters the sinus cavity 63.

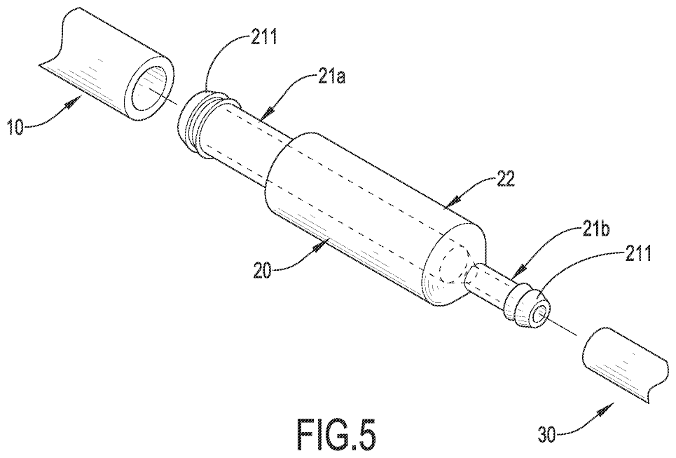

With reference to FIG. 5, a second embodiment of a removing device for dentistry in accordance with the present invention is substantially the same as the first embodiment except for the following features. The controller 20 has at least one engaging rib 211 formed on and protruded from an external surface of each one of the two connecting portions 21a, 21b, so that the controller 20 engages with the connecting pipe 10 and the sucking tube 30 by each one of the at least one engaging rib 211, and this can prevent the connecting pipe 10 and the sucking tube 30 from being separated from the controller 20. Furthermore, each of the at least one engaging rib 211 located on each of the two connecting portions 21a, 21b has a wedge-shaped cross section. Preferably, the controller 20 has multiple engaging ribs 211 arranged at spaced intervals on each connecting portion 21a, 21b.

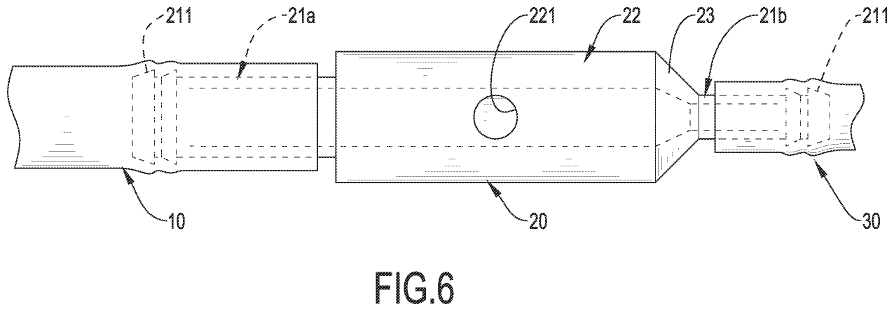

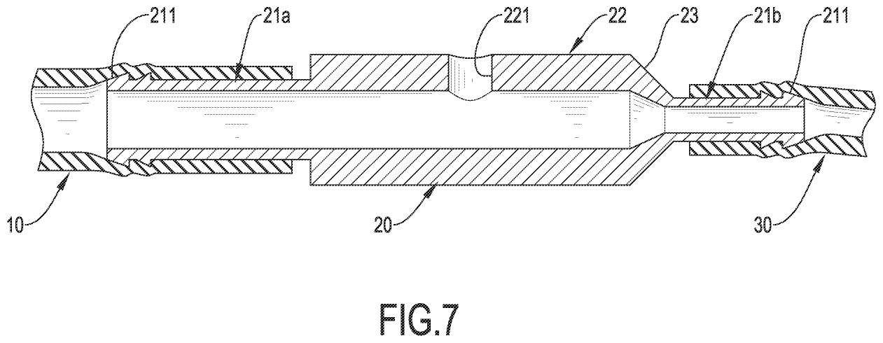

With reference to FIGS. 6 and 7, a third embodiment of a removing device for dentistry in accordance with the present invention is substantially the same as the first embodiment except for the following features. The operating portion 22 has a relief hole 221 formed through an external surface thereof and in fluid communication with the two connecting portions 21a, 21b. Preferably, the relief hole 221 is radially formed through the external surface of the operating portion 22. The sucking tube 30 is a tube body made of a soft material and connected to the connecting portion 21b opposite to the connecting pipe 10, so that the connecting pipe 10 can communicate with the sucking tube 30 via the controller 20. Furthermore, the controller 20 has a tapered portion 23 formed thereon adjacent to the connecting portion 21b that is connected to the sucking tube 30.

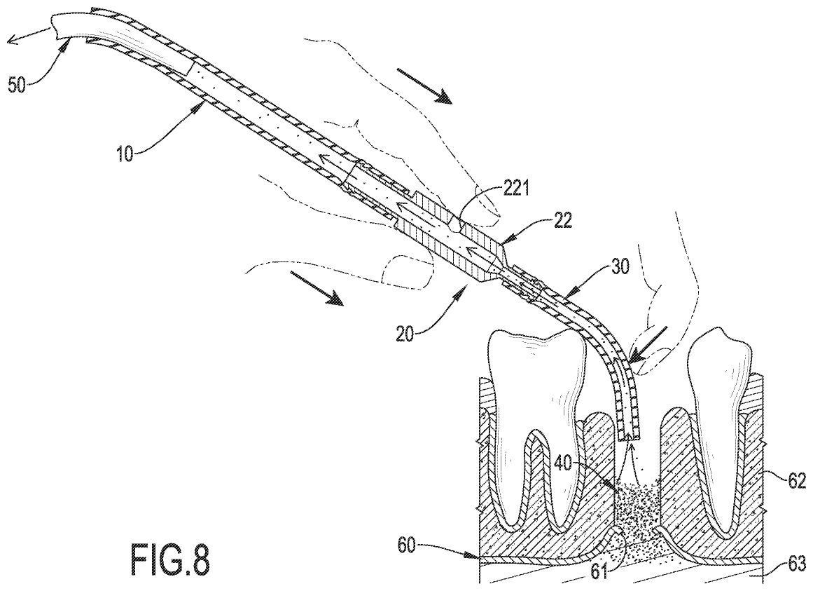

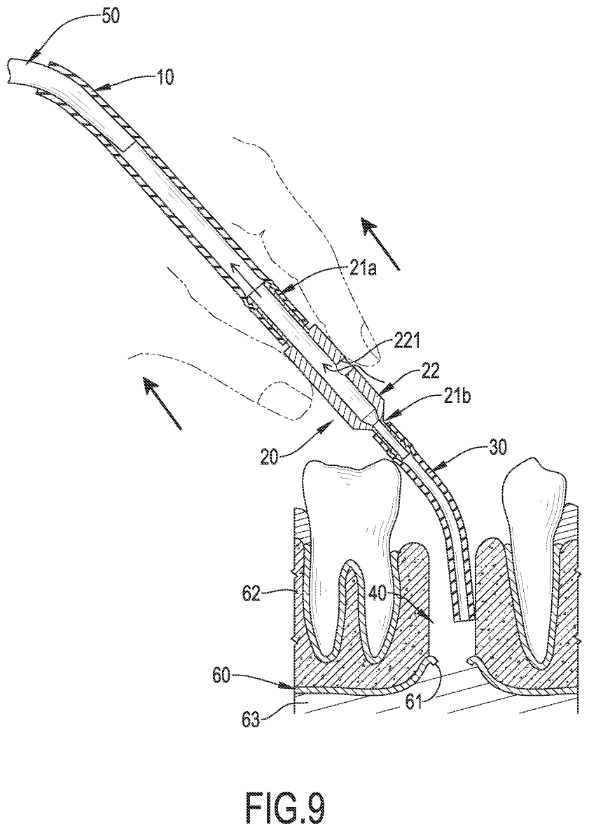

With reference to FIGS. 8 and 9, when the third embodiment of the removing device for dentistry of the present invention is in use, the connecting pipe 10 is connected to the water suction/high power suction 50 by the dentist, and the dentist can hold the controller 20 by one hand to move the sucking tube 30 at the patient's alveolar bone 62 or the other hand assists in moving the sucking tube 30 at the alveolar bone 62. With reference to FIG. 8, the dentist covers the relief hole 221 by fingers, so that the gas suction in the water suction/high power suction 50 can be transmitted to the sucking tube 30, and the bone graft 40 that enters the sinus cavity 63 can be sucked out through the sucking tube 30 to prevent the bone graft 40 from blocking the sinus opening of the maxillary sinus to generate infection and suppuration in the sinus cavity 63. Furthermore, during the operation of removing the bone graft 40, the dentist can separate the finger from or approach the relief hole 221 as shown in FIG. 9 to make the sucking tube 30 produce an intermittent suction force. Firstly, it can cooperate with the dentist to adjust the actual situation of the suction force. Secondly, it can avoid the effect of continuous suction force on the patient, and it is quite convenient to use and operate. The bone grail 40 that has entered the sinus cavity 63 can be quickly removed.

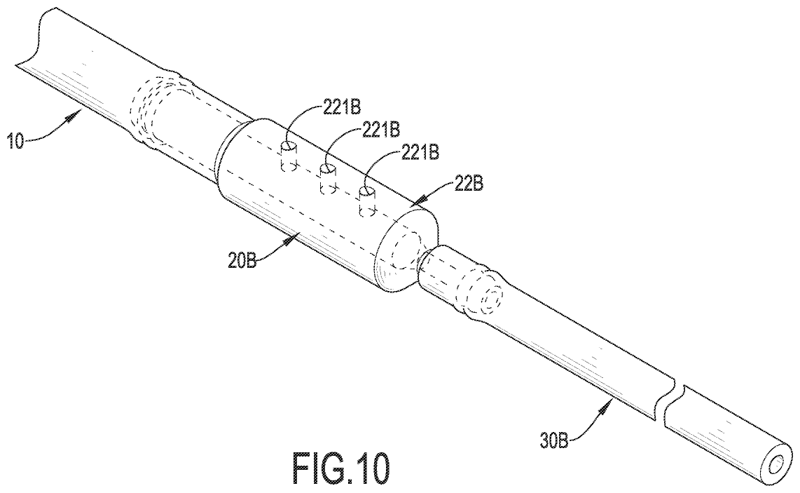

With reference to FIG. 10, a fourth embodiment of a removing device for dentistry in accordance with the present invention is substantially the same as the third embodiment except for the following features. The controller 20B has multiple relief holes 221B formed on the operating portion 22B, and the multiple relief holes 221B are disposed on the operating portion 22B at spaced intervals. Additionally, an inner diameter of each relief hole 221B of the fourth embodiment is smaller than an inner diameter of the relief hole 221 of the third embodiment. When the fourth embodiment of the removing device for dentistry of the present invention is operated by the dentist, the multiple relief holes 221B can be all open or covered in different numbers (such as one, two or three) by the dentist to provide different suction forces to the sucking tube 30B to provide improved surgical quality.

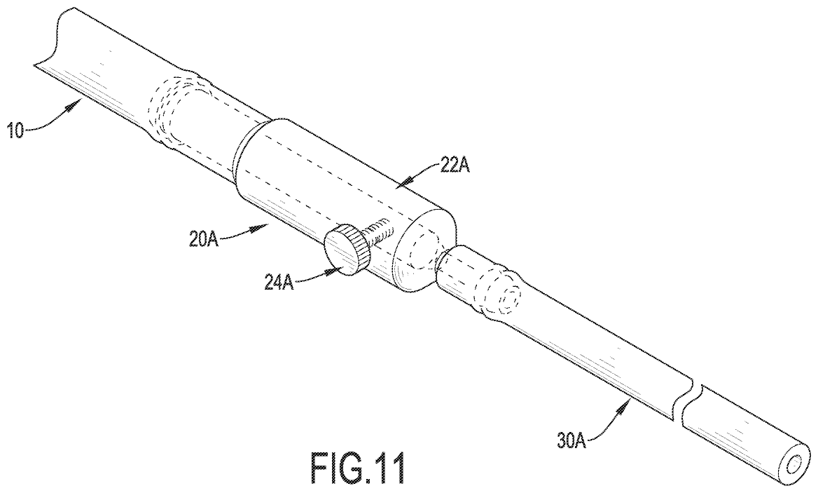

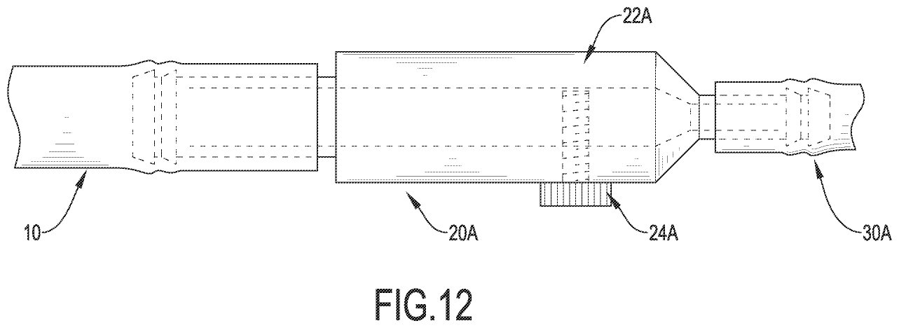

With reference to FIGS. 11 and 12, a fifth embodiment of a removing device for dentistry in accordance with the present invention is substantially the same as the second embodiment except for the following features. The controller 20A has a flow regulator 24A rotatably and radially mounted through the operating portion 22A of the controller 20A to adjust air flows through the operating portion 22A, and then adjust the sucking force of the sucking tube 30A. Preferably, the flow regulator 24A may be a screw bolt connected to the operating portion 22A. When the fifth embodiment of the removing device for dentistry of the present invention is in use, by rotating the flow regulator 24A, the suction force of air entering the sucking tube 30A via the controller 20A is changed, so that the dentist can more accurately control the suction force of the sucking tube 30A to perform related sucking operations, which can provide improved surgical quality.

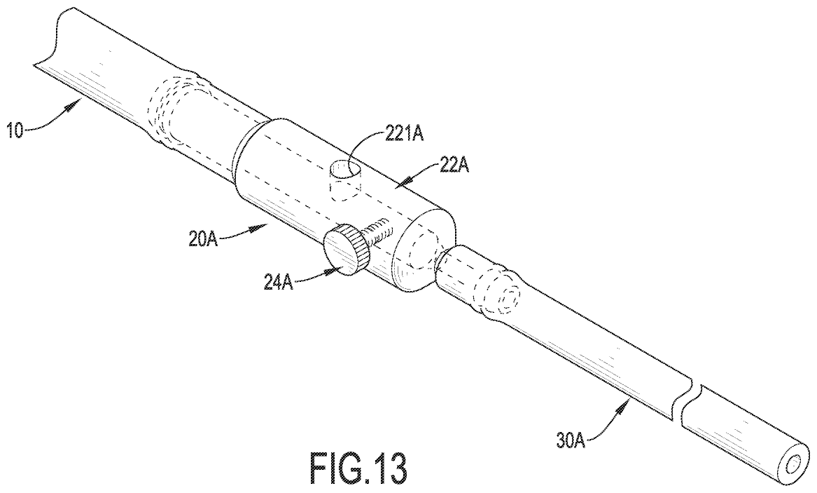

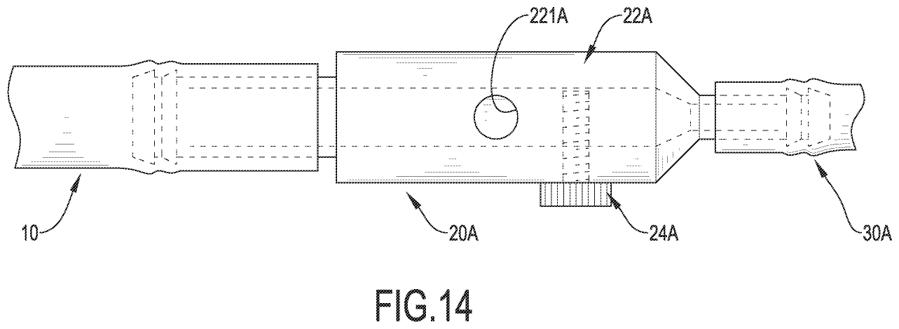

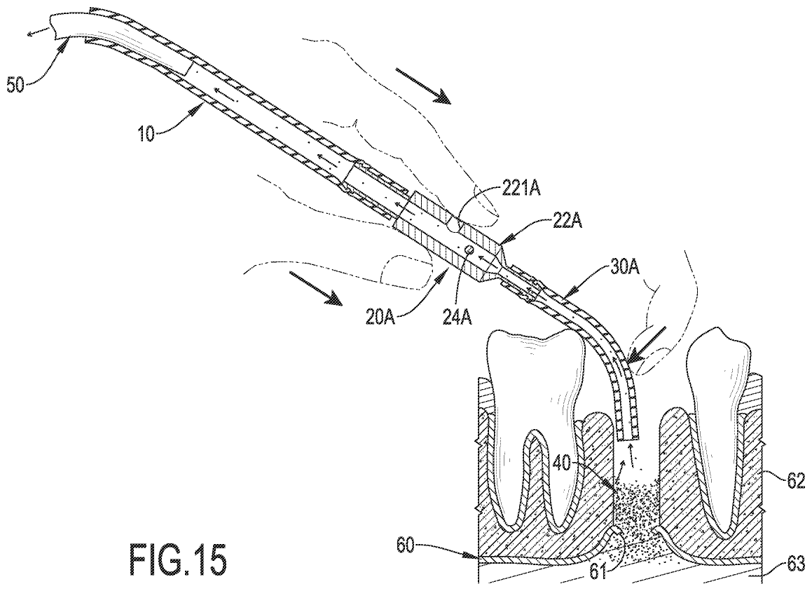

With reference to FIGS. 13 and 14, a sixth embodiment of a removing device for dentistry in accordance with the present invention is substantially the same as the fifth embodiment except for the following features. The controller 20A has both the relief hole 221A and the flow regulator 24A, With reference to FIG. 15, when the sixth embodiment of the removing device for dentistry of the present invention is in use, the suction force of the sucking tube 30A that is transmitted from the water suction/high power suction 50 can be adjusted by fully opening, fully shielding, semi-shielding or partially shielding the relief hole 221A with fingers, and it can be further rotated by rotating the flow regulator 24A to change the suction force of air entering the sucking tube 30A via the controller 20A, so that the surgeon can more accurately control the suction force of the sucking tube 30A to perform related sucking operations, which can provide improved surgical quality.

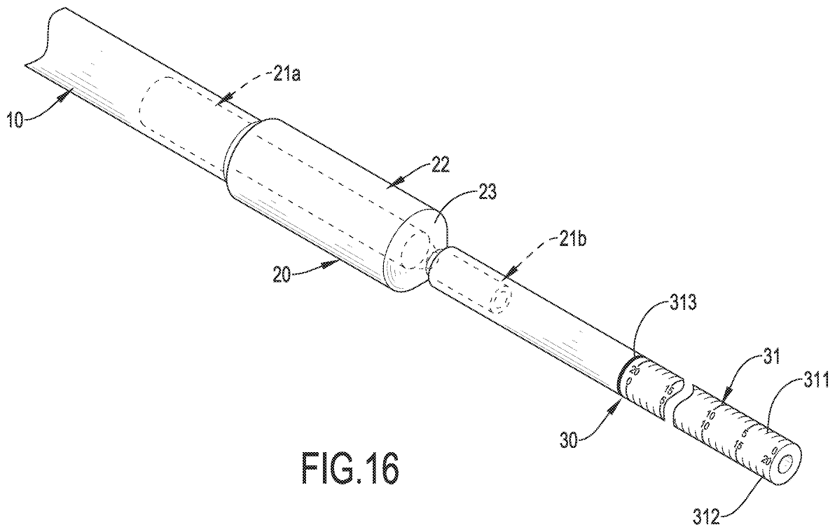

With reference to FIG. 16, a seventh embodiment of a removing device for dentistry in accordance with the present invention is substantially the same as the first embodiment except for the following features. The sucking tube 30 has a scale 31 formed on a free end thereof distal from the controller 20, the scale 31 can be marked on an external surface of the sucking tube 30 by a laser beam, and the laser beam can be an ultraviolet laser. It also can be marked by other mechanical marking methods or ink printing methods. Furthermore, the scale 31 has a forward mark 311 and a reverse mark 312, wherein the forward mark 311 is formed from the free end of the sucking tube 30 toward the controller 20, a symbol that indicates a gradual increase in length (for example: 0 mm to 20 mm), and the reverse mark 312 is a symbol that indicates a gradual decrease in length toward the free end of the sucking tube 30 (for example: 20 mm to 0 mm). The scale 31 has a prompt symbol 313 formed on a side of the reverse mark 312 away from the free end of the sucking tube 30.

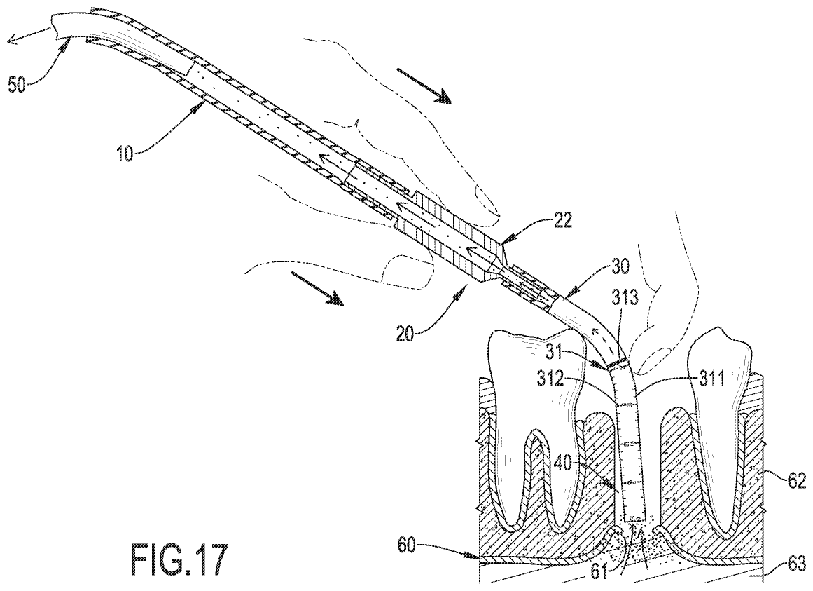

With reference to FIG. 17, when the seventh embodiment of the removing device for dentistry of the present invention is in use, when the sucking tube 30 is moved deep into the patient's oral cavity to remove the bone graft 40, the predetermined drilling depth during dental implantation can be matched with a corresponding length of the sucking tube 30, and the length of the sucking tube 30 can be cut according to the reverse mark 312, so that when the dentist moves the sucking tube 30 into the alveolar bone 62 of the patient, the free end of the sucking tube 30 will not extend too much into the sinus cavity 63, but will be located at the hole 61 for removing the bone graft 40 that drops into the sinus cavity 63. While the sucking tube 30 is inserted, the prompt symbol 313 on the side of the reverse mark 312 can be used to remind the dentist that the free end of the sucking tube 30 is located in the hole 61. Therefore, the dentist can accurately remove the bone graft 40 located at the hole 61, and can prevent the sucking tube 30 from overextending into the sinus cavity 63.

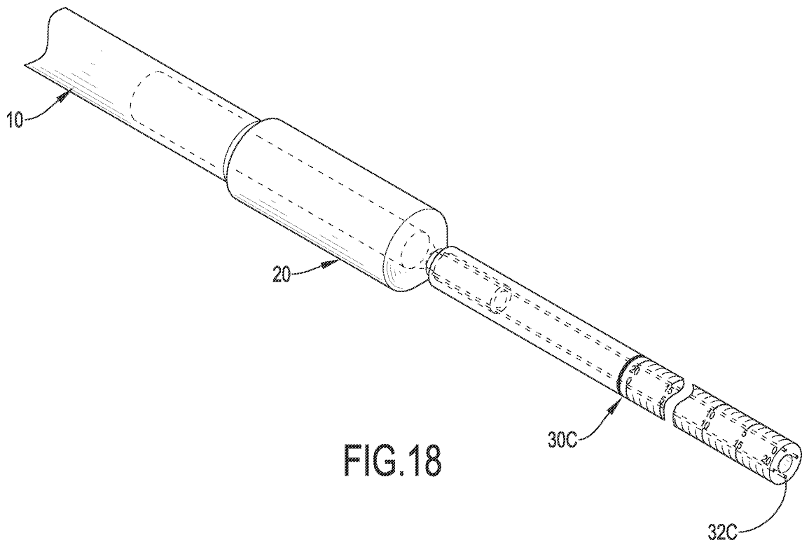

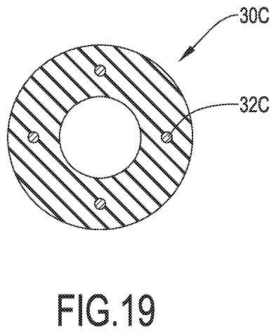

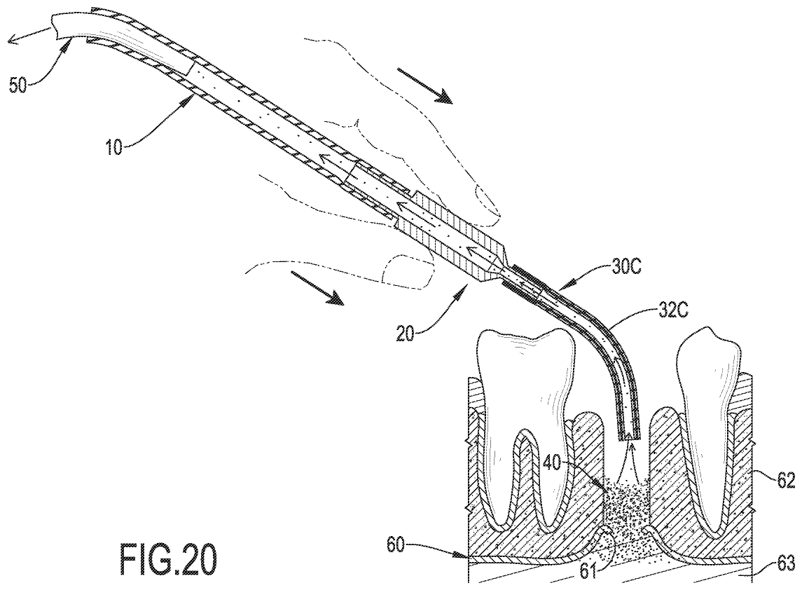

With reference to FIGS. 18 and 19, an eighth embodiment of a removing device for dentistry in accordance with the present invention is substantially the same as the seventh embodiment except for the following features. The sucking tube 30C has at least one supporting element 32C to maintain the sucking tube 30C in a curved shape, so that the dentist can adjust the curved shape and angle of the sucking tube 30A as needed, and the dentist can use it with one-handed operation. It is no longer necessary to use both hands for operation. Preferably, the at least one supporting element 32C can be disposed on one of the positions of the external surface, the inner portion, and the internal surface of the sucking tube 30C, as long as to provide a supporting effect to the sucking tube 30C. Furthermore, the sucking tube 30C has multiple supporting elements 32C, and the supporting elements 32C are arranged in parallel at spaced intervals on the sucking tube 30C. With reference to FIG. 20, when the eighth embodiment of the removing device for dentistry of the present invention is in use, a bending shape and angle of the sucking tube 30C can be adjusted and changed by bending the at least one supporting element 32C according to the needs of the dentist, and can be easily extended into the patient's oral cavity by one-handed control to perform dental removal operations such as suction of liquid or removal of bone graft 40.

According to the above-mentioned technical features of the removing device for dentistry in accordance with the present invention, in use, not only the removing device for dentistry of the present invention can be used conveniently with the hard water suction/high power suction 50, but also the soft material of the sucking tube 30, 30A, 30B, 30C can avoid the pain caused by collision during operation, and can be adjusted according to the dentist's needs, which greatly improves the practicability of the water suction/high power suction 50. When removing the bone graft 40, the dentist only needs to move the sucking tube 30, 30A, 30B, 30C to the alveolar bone 62 of the patient, and then through the operating portion 22 or pressing the operating portion 22 to fully open, fully shield, half shield or partially shield the at least one relief hole 221, 221A, 221B or adjusting the flow regulator 24A to accurately control the operation of the suction force, it is convenient to perform the removal operation of the bone graft 40. This not only removes the bone graft 40 entering the sinus cavity 63 quickly, but also avoids the infection and suppuration of the maxillary sinus due to the bone graft 40 blocking the sinus opening of the maxillary sinus. It can also avoid the subsequent need to transfer the patient to an otolaryngologist for surgery, thereby avoiding health risks and medical disputes. In addition, the removing device for dentistry of the present invention has a simplified structure that can be manufactured and produced conveniently, and allows the dentist to operate easily and quickly get started, and effectively solves the problem the surgeon encounters during dental implantation, to provide a removing device for dentistry that can be used and manufactured conveniently and can be removed quickly.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A removing device for dentistry comprising:
a connecting pipe;
a controller, the controller connected to the connecting pipe and having
two connecting portions, and one of the two connecting portions connected to the connecting pipe; and
an operating portion disposed between the two connecting portions to connect the two connecting portions in fluid communication with each other; and
a sucking tube, the sucking tube connected to the other one of the two connecting portions opposite to the connecting pipe to connect in fluid communication with the connecting pipe via the controller.

2. The removing device for dentistry as claimed in claim 1, wherein the controller has at least one engaging rib formed on and protruded from an external surface of each one of the two connecting portions to enable the controller to engage with the connecting pipe and the sucking tube by each one of the at least one engaging rib to prevent the connecting pipe and the sucking tube separating from the controller.

3. The removing device for dentistry as claimed in claim 2, wherein each of the at least one engaging rib located on each of the two connecting portions has a wedge-shaped cross section.

4. The removing device for dentistry as claimed in claim 3, wherein the controller has multiple engaging ribs arranged at spaced intervals on each one of the two connecting portions.

5. The removing device for dentistry as claimed in claim 1, wherein the operating portion has at least one relief hole formed through an external surface thereof and in fluid communication with the two connecting portions.

6. The removing device for dentistry as claimed in claim 2, wherein the operating portion has at least one relief hole formed through an external surface thereof and in fluid communication with the two connecting portions.

7. The removing device for dentistry as claimed in claim 3, wherein the operating portion has at least one relief hole formed through an external surface thereof and in fluid communication with the two connecting portions.

8. The removing device for dentistry as claimed in claim 4, wherein the operating portion has at least one relief hole formed through an external surface thereof and in fluid communication with the two connecting portions.

9. The removing device for dentistry as claimed in claim 1, wherein the controller has multiple relief holes formed on the operating portion, and the multiple relief holes are disposed on the operating portion at spaced intervals and are in fluid communication with the two connecting portions.

10. The removing device for dentistry as claimed in claim 2, wherein the controller has multiple relief holes formed on the operating portion, and the multiple relief holes are disposed on the operating portion at spaced intervals and are in fluid communication with the two connecting portions.

11. The removing device for dentistry as claimed in claim 3, wherein the controller has multiple relief holes formed on the operating portion, and the multiple relief holes are disposed on the operating portion at spaced intervals and are in fluid communication with the two connecting portions.

12. The removing device for dentistry as claimed in claim 4, wherein the controller has multiple relief holes formed on the operating portion, and the multiple relief holes are disposed on the operating portion at spaced intervals and are in fluid communication with the two connecting portions.

13. The removing device for dentistry as claimed in claim 1, wherein the controller has a flow regulator rotatably and radially mounted through the operating portion of the controller to adjust air flows through the operating portion to adjust a sucking force of the sucking tube.

14. The removing device for dentistry as claimed in claim 2, wherein the controller has a flow regulator rotatably and radially mounted through the operating portion of the controller to adjust air flows through the operating portion to adjust a sucking force of the sucking tube.

15. The removing device for dentistry as claimed in claim 3, wherein the controller has a flow regulator rotatably and radially mounted through the operating portion of the controller to adjust air flows through the operating portion to adjust a sucking force of the sucking tube.

16. The removing device for dentistry as claimed in claim 4, wherein the controller has a flow regulator rotatably and radially mounted through the operating portion of the controller to adjust air flows through the operating portion to adjust a sucking force of the sucking tube.

17. The removing device for dentistry as claimed in claim 13, wherein the operating portion has at least one relief hole formed through an external surface thereof and in fluid communication with the two connecting portions.

18. The removing device for dentistry as claimed in claim 14, wherein the operating portion has at least one relief hole formed through an external surface thereof and in fluid communication with the two connecting portions.

19. The removing device for dentistry as claimed in claim 15, wherein the operating portion has at least one relief hole formed through an external surface thereof and in fluid communication with the two connecting portions.

20. The removing device for dentistry as claimed in claim 16, wherein the operating portion has at least one relief hole formed through an external surface thereof and in fluid communication with the two connecting portions.

21. The removing device for dentistry as claimed in claim 1, wherein the sucking tube has a scale formed on a free end thereof distal from the controller.

22. The removing device for dentistry as claimed in claim 2, wherein the sucking tube has a scale formed on a free end thereof distal from the controller.

23. The removing device for dentistry as claimed in claim 3, wherein the sucking tube has a scale formed on a free end thereof distal from the controller.

24. The removing device for dentistry as claimed in claim 4, wherein the sucking tube has a scale formed on a free end thereof distal from the controller.

25. The removing device for dentistry as claimed in claim 21, wherein
the scale has a forward mark and a reverse mark;
the forward mark is formed from the free end of the sucking tube toward the controller and is a symbol that indicates a gradual increase in length; and
the reverse mark is formed toward the free end of the sucking tube and is a symbol that indicates a gradual decrease in length toward the free end of the sucking tube.

26. The removing device for dentistry as claimed in claim 22, wherein
the scale has a forward mark and a reverse mark;
the forward mark is formed from the free end of the sucking tube toward the controller and is a symbol that indicates a gradual increase in length; and
the reverse mark is formed toward the free end of the sucking tube and is a symbol that indicates a gradual decrease in length toward the free end of the sucking tube.

27. The removing device for dentistry as claimed in claim 23, wherein
the scale has a forward mark and a reverse mark;
the forward mark is formed from the free end of the sucking tube toward the controller and is a symbol that indicates a gradual increase in length; and
the reverse mark is formed toward the free end of the sucking tube and is a symbol that indicates a gradual decrease in length toward the free end of the sucking tube.

28. The removing device for dentistry as claimed in claim 24, wherein
the scale has a forward mark and a reverse mark;
the forward mark is formed from the free end of the sucking tube toward the controller and is a symbol that indicates a gradual increase in length; and
the reverse mark is formed toward the free end of the sucking tube and is a symbol that indicates a gradual decrease in length toward the free end of the sucking tube.

29. The removing device for dentistry as claimed in claim 25, wherein the scale has a prompt symbol formed on a side of the reverse mark away from the free end of the sucking tube.

30. The removing device for dentistry as claimed in claim 26, wherein the scale has a prompt symbol formed on a side of the reverse mark away from the free end of the sucking tube.

31. The removing device for dentistry as claimed in claim 27, wherein the scale has a prompt symbol formed on a side of the reverse mark away from the free end of the sucking tube.

32. The removing device for dentistry as claimed in claim 28, wherein the scale has a prompt symbol formed on a side of the reverse mark away from the free end of the sucking tube.

33. The removing device for dentistry as claimed in claim 21, wherein the sucking tube has at least one supporting element to maintain the sucking tube in a curved shape.

34. The removing device for dentistry as claimed in claim 22, wherein the sucking tube has at least one supporting element to maintain the sucking tube in a curved shape.

35. The removing device for dentistry as claimed in claim 23, wherein the sucking tube has at least one supporting element to maintain the sucking tube in a curved shape.

36. The removing device for dentistry as claimed in claim 24, wherein the sucking tube has at least one supporting element to maintain the sucking tube in a curved shape.

37. The removing device for dentistry as claimed in claim 33, wherein the at least one supporting element is disposed on one of the positions of an external surface, an inner portion and an internal surface of the sucking tube.

38. The removing device for dentistry as claimed in claim 34, wherein the at least one supporting element is disposed on one of the positions of an external surface, an inner portion and an internal surface of the sucking tube.

39. The removing device for dentistry as claimed in claim 35, wherein the at least one supporting element is disposed on one of the positions of an external surface, an inner portion and an internal surface of the sucking tube.

40. The removing device for dentistry as claimed in claim 36, wherein the at least one supporting element is disposed on one of the positions of an external surface, an inner portion and an internal surface of the sucking tube.

41. The removing device for dentistry as claimed in claim 37, wherein the sucking tube has multiple supporting elements, and the supporting elements are arranged in parallel at spaced intervals on the sucking tube.

42. The removing device for dentistry as claimed in claim 38, wherein the sucking tube has multiple supporting elements, and the supporting elements are arranged in parallel at spaced intervals on the sucking tube.

43. The removing device for dentistry as claimed in claim 39, wherein the sucking tube has multiple supporting elements, and the supporting elements are arranged in parallel at spaced intervals on the sucking tube.

44. The removing device for dentistry as claimed in claim 40, wherein the sucking tube has multiple supporting elements, and the supporting elements are arranged in parallel at spaced intervals on the sucking tube.

45. The removing device for dentistry as claimed in claim 1, wherein the controller has a tapered portion formed thereon adjacent to the connecting portion that is connected to the sucking tube.

46. The removing device for dentistry as claimed in claim 2, wherein the controller has a tapered portion formed thereon adjacent to the connecting portion that is connected to the sucking tube.

47. The removing device for dentistry as claimed in claim 3, wherein the controller has a tapered portion formed thereon adjacent to the connecting portion that is connected to the sucking tube.

48. The removing device for dentistry as claimed in claim 4, wherein the controller has a tapered portion formed thereon adjacent to the connecting portion that is connected to the sucking tube.
